(19) United States
(12) Patent Application Publication
(10) Pub. No.: US 2018/0361963 A1
(43) Pub. Date: Dec. 20, 2018

(54) REAR BUMPER FOR VEHICLE AND EXHAUST GAS GUIDING STRUCTURE WITH REAR BUMPER

(71) Applicant: HONDA MOTOR CO., LTD., TOKYO (JP)

(72) Inventors: Hirofumi TANAKA, WAKO-SHI (JP); Siniu PENG, BEIJING (CN)

(21) Appl. No.: 16/006,069

(22) Filed: Jun. 12, 2018

(30) Foreign Application Priority Data
Jun. 14, 2017 (CN) 201710446447.5

(51) Int. Cl. B60R 19/02; B60K 13/04

(52) U.S. Cl. CPC B60R 19/023; B60K 13/04

(57) ABSTRACT

The present invention provides a rear bumper for a vehicle, the rear bumper includes: a bottom horizontal part and an exhaust gas guiding part; wherein the bottom horizontal part is provided with a notch extending from a front edge of the bottom horizontal part toward a rear edge side of the bottom horizontal part, and the exhaust gas guiding part is arranged above the notch; the exhaust gas guiding part includes a protruding part protruding toward above the rear bumper, and a height of the protruding part at the front edge side of the bottom horizontal part is greater than a height of the protruding part at the rear edge side of the bottom horizontal part.

### CROSS-REFERENCE TO RELATED APPLICATION

Priority is claimed on Chinese Patent Application No. 201710446447.5, filed Jun. 14, 2017, the content of which is incorporated herein by reference.

### BACKGROUND OF THE INVENTION

### Field of the Invention

The present invention relates to the field of vehicles, and particularly relates to a rear bumper for a vehicle and an exhaust gas guiding structure with the rear bumper.

### Description of the Related Art

Generally, a vehicle is provided with an exhaust pipe at its rear for discharging the exhaust gas. To ensure that the exhaust gas is discharged out of the vehicle, the end of the exhaust pipe usually needs extension to the rear side of the rear bumper.

FIG. 1 shows a diagram of the existing exhaust gas guiding structure in the prior art. As shown in FIG. 1, the exhaust pipe 206 is designed to have a large curvature and extend toward the below of the bottom horizontal part 204-1 of the rear bumper 202-1. The rear end of the exhaust pipe is basically flush with the rear edge of the bottom horizontal part 204-1 in order to ensure that exhaust gas is able to be discharged out of the vehicle.

FIG. 2 shows another diagram of the existing exhaust gas guiding structure. As shown in FIG. 2, the rear bumper 1 is provided with a left opening and a right opening at the bottom of the rear side. The exhaust pipe is extended into one opening and provided with a decorating part 3, wherein the decorating part 3 is fixed by a fixing means (not shown) arranged at the opening of the rear bumper 1.

It should be noted that the introduction to the above background is set forth only for the convenience of clearly and fully explaining the technical solutions of the present invention and enabling those skilled in the art to understand them. It cannot be deemed true that the above technical solutions are well known to those skilled in the art only due to the statement of those solutions in the background of the present invention.

### SUMMARY OF THE INVENTION

In the prior art shown in FIG. 1, because the exhaust pipe is designed to have a large curvature and go around to below the rear bumper, the opening at the end of the exhaust pipe directly faces against the exterior of the vehicle and the opening of the exhaust pipe can be directly seen from the behind of the vehicle, the appearance of the vehicle rear part is affected. In the prior art shown in FIG. 2, because the opening is arranged at the rear side of the bumper, even if the decorating part is arranged, the opening still affects the appearance of the rear bumper. Because the opening at the end of the exhaust pipe is close to the rear bumper, high-temperature exhaust gas discharged from the opening is easy to contaminate the rear surface (visible face) of the rear bumper; moreover, because the decorating part and the fixing means for fixing the decorating part need to be additionally arranged, the production cost and the assembly difficulty are increased.

In order to solve the above problem, the present invention provides a rear bumper for a vehicle and an exhaust gas guiding structure with the rear bumper. Exhaust gas discharged from an exhaust pipe can be guided outside the vehicle, backflow of exhaust gas into the vehicle can be effectively reduced, and meanwhile, the beautiful appearance of the vehicle can be achieved. Moreover, the visible face of the rear bumper is not easy to be contaminated by the discharged exhaust gas, resulting in high durability. In addition, manufacturing and assembly are convenient and the production cost is low.

According to the first aspect of the present invention, a rear bumper for a vehicle is provided, wherein the rear bumper includes a bottom horizontal part and an exhaust gas guiding part, wherein the bottom horizontal part is provided with a notch extending from a front edge of the bottom horizontal part toward a rear edge side of the bottom horizontal part, the exhaust gas guiding part is arranged above the notch, the exhaust gas guiding part includes a protruding part protruding toward above the rear bumper, and a height of the protruding part at the front edge side of the bottom horizontal part is greater than a height of the protruding part at the rear edge side of the bottom horizontal part.

In the second aspect of the present invention, according to the first aspect of the present invention, the exhaust gas guiding part may be arranged so as not to protrude from the front edge of the bottom horizontal part in a longitudinal direction of the vehicle.

In the third aspect of the present invention, according to the first aspect of the present invention, a rear edge of the notch may be arranged so as not to protrude from a rear edge of the bottom horizontal part.

In the fourth aspect of the present invention, according to the first aspect of the present invention, the exhaust gas guiding part and the bottom horizontal part of the rear bumper may be integrally formed.

In the fifth aspect of the present invention, according to the fourth aspect of the present invention, the exhaust gas guiding part may further include a combining section, and the combining section and a rear edge of the notch may be combined to form a hinge structure.

In the sixth aspect of the present invention, according to the any one of the first to fifth aspects of the present invention, the exhaust gas guiding part may further include a connecting part, and the connecting part may be movably or fixedly connected with the bottom horizontal part at one side in a lateral direction of the vehicle.

In the seventh aspect of the present invention, according to any one of the first to fifth aspects of the present invention, the height of the protruding part may be gradually decreased from front to back along the longitudinal direction of the vehicle.

In the eighth aspect of the present invention, according to the seventh aspect of the present invention, a cross-section of the protruding part may be an arc-shaped curved surface.

In the ninth aspect of the present invention, according to any one of the first to eighth aspects of the present invention, an exhaust gas guiding structure is provided, wherein the exhaust gas guiding structure includes: the rear bumper according to any of the first aspect to the ninth aspect of the embodiments of the present invention; and an exhaust pipe in which a rear end thereof is arranged at a position corresponding to the exhaust gas guiding part of the rear bumper, and wherein the rear end of the exhaust pipe is arranged so as not to protrude from the rear end of the notch of the rear bumper in the longitudinal direction of the vehicle.

In the tenth aspect of the present invention, according to the ninth aspect the present invention, the rear end of the exhaust pipe may be arranged along a shape of the protruding part of the exhaust gas guiding part.

In the eleventh aspect of the present invention, according to the ninth aspect of the present invention, an opening at the rear end of the exhaust pipe may be arranged such that an angle between the opening and a horizontal plane is smaller than a predetermined angle.

In the aspect of the present invention, because the bottom horizontal part of the rear bumper is provided with a notch, the notch is provided with an exhaust gas guiding part, and the exhaust gas guiding part and the bottom horizontal part jointly constitute a blocking surface, the blocking surface prevent backflow of exhaust gas, the exhaust gas discharged by the exhaust pipe can be guided outside the vehicle, and backflow of exhaust gas into the vehicle can be effectively reduced; meanwhile, because the height at the front side of the protruding part of the exhaust gas guiding part is greater than the height at the rear side and the rear end of the exhaust pipe is arranged in a position corresponding to the exhaust gas guiding part, the exhaust pipe is impossible or not easy to see from behind the vehicle, so that the beautiful appearance of the vehicle can be achieved; moreover, because the opening at the rear end of the exhaust pipe is far away from the visible face of the rear bumper, the visible face of the rear bumper is not easy to be contaminated by the exhaust gas discharged, resulting in its having high durability; and in addition, the structure of arranging the notch and arranging the exhaust gas guiding part on the notch is simple, manufacturing and assembly are convenient and the production cost is low.

Furthermore, the exhaust gas guiding part is arranged so as not to protrude from the front edge of the bottom horizontal part in the longitudinal direction of the vehicle, which can further achieve that the exhaust pipe is impossible or not easy to see from behind the vehicle, so that the beautiful appearance of the vehicle can be achieved.

Furthermore, the rear edge of the notch is arranged so as not to protrude from the rear edge of the bottom horizontal part, which can further achieve that the exhaust pipe is impossible or not easy to see from behind the vehicle, so that the beautiful appearance of the vehicle can be achieved.

Furthermore, the exhaust gas guiding part and the bottom horizontal part of the rear bumper are integrally formed. In this way, the working procedure and the number of parts can be reduced, the assembly difficulty is further reduced, the assembly accuracy is increased and the cost is saved.

Furthermore, the exhaust gas guiding part also has a combining section, and the combining section and the rear edge of the notch are combined to form a hinge structure. In this way, it is further convenient for installation and maintenance through the combination mode of the hinge structure.

Furthermore, the exhaust gas guiding part also has a connecting part, and the connecting part is movably or fixedly connected with the bottom horizontal part at one side in the lateral direction of the vehicle. In this way, fixation in movable connection mode is further convenient for installation and maintenance, and the exhaust gas guiding part can be firmly installed on the bottom horizontal part through fixed connection mode.

Furthermore, the height of the protruding part is gradually decreased from front to back along the longitudinal direction of the vehicle, which is convenient for the installation of the exhaust pipe and can further achieve that the exhaust pipe is impossible or not easy to see from behind the vehicle, so that the beautiful appearance of the vehicle can be achieved.

Furthermore, the cross-section of the protruding part is an arc-shaped curved surface. In this way, the curvature of the exhaust pipe itself can be reduced, and exhaust gas can be discharged easily.

Furthermore, the rear end of the exhaust pipe is arranged so as not to protrude from the rear edge of the notch of the rear bumper in the longitudinal direction of the vehicle, which can further achieve that the exhaust pipe is impossible or not easy to see from behind the vehicle, so that the beautiful appearance of the vehicle can be achieved.

Furthermore, the rear end of the exhaust pipe is arranged along the shape of the protruding part of the exhaust gas guiding part, which can further improve the exhaust gas guiding effect and further achieve that the exhaust pipe is impossible or not easy to see from behind the vehicle, so that the beautiful appearance of the vehicle can be achieved.

Furthermore, the opening at the rear end of the exhaust pipe is arranged such that the angle between the opening and the horizontal plane is smaller than the predetermined angle. In this way, the plane of the opening is close to the horizontal plane as much as possible, the exhaust pipe is avoided from being seen from behind to the utmost extent while exhaust gas can be discharged, and meanwhile, the effect of preventing backflow of exhaust gas can be further enhanced by changing the discharge direction of the exhaust gas.

Embodiments are disclosed in detail in the present invention by reference to the description and drawings below. It should be understood that the embodiments of the present invention will not be therefore restricted in terms of the scope. Within the scope of the attached claims, the embodiments of the present invention include various alterations, variations and equivalents.

Features described and/or shown for one embodiment can be used for one or more other embodiments in the same or similar way, be combined with features in other embodiments, or supersede features in other embodiments.

It should be emphasized that the term “comprise/include/have” refers to the existence of features, whole pieces or components, but does not exclude the existence or addition of one or more other features, whole pieces or components.

The foregoing and other purposes, features and advantages of the embodiments of the present invention will become more obvious from the following detailed description in combination with the drawings.

### BRIEF DESCRIPTION OF THE DRAWINGS

FIG. 1 shows a diagram of the existing exhaust gas guiding structure;

FIG. 2 shows another diagram of the existing exhaust gas guiding structure;

FIG. 3 shows a top view of the rear bumper in the first embodiment of the present invention;

FIG. 4 shows an enlarged view of the part A in FIG. 3;

FIG. 5 shows a front view of the rear bumper in the first embodiment of the present invention;

FIG. 6 shows a top view of the rear bumper with the exhaust gas guiding part omitted in the first embodiment of the present invention;

FIG. 7 shows a bottom view of the rear bumper with the exhaust gas guiding part omitted in the first embodiment of the present invention;

FIG. 8 shows a top view after the exhaust gas guiding part and the bottom horizontal part of the rear bumper are integrally formed in the first embodiment of the present invention;

FIG. 9 shows a bottom view after the exhaust gas guiding part and the bottom horizontal part of the rear bumper are integrally formed in the first embodiment of the present invention;

FIG. 10 shows a rear view after the exhaust gas guiding part and the bottom horizontal part of the rear bumper are integrally formed in the first embodiment of the present invention;

FIG. 11 shows a bottom view of the exhaust gas guiding structure in the second embodiment of the present invention; and

FIG. 12 shows a side-section diagram of the exhaust gas guiding structure in the second embodiment of the present invention.

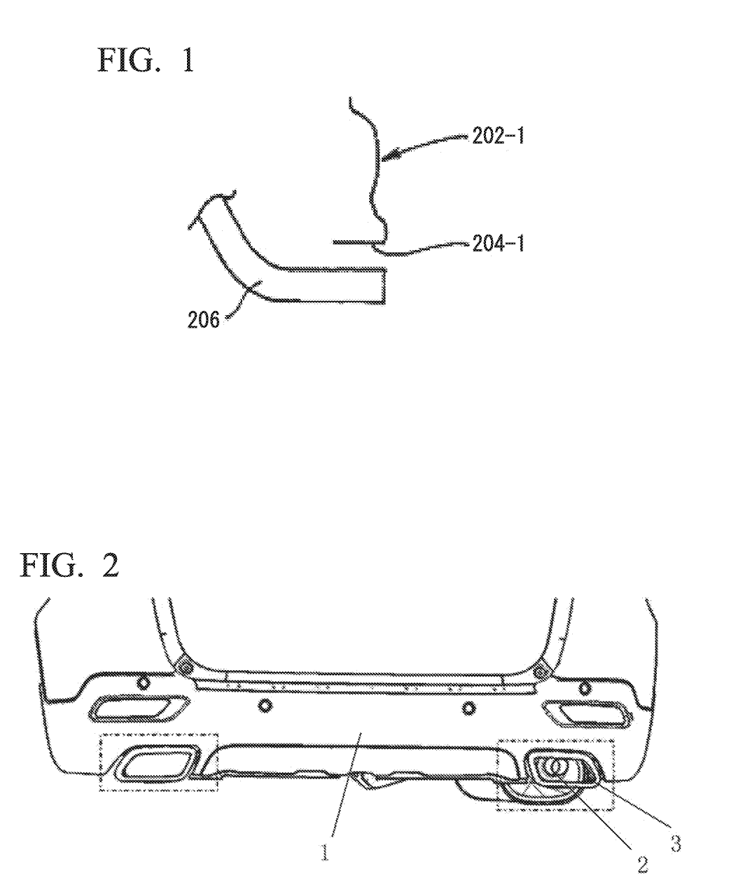

### DETAILED DESCRIPTION OF THE INVENTION

The foregoing and other features of the present invention will become obvious by reference to the drawings and through the specification below. The specification and the drawings disclose specific embodiments of the present invention, which belong to embodiments able to adopt the principle of the present invention. It should be known that the present invention is not limited to the described embodiments but includes all alterations, variations and equivalents within the scope of the invention.

In the embodiments of the present invention, the vehicle can be one of any type with a rear bumper and an exhaust pipe, such as an automobile, motorcycle or agricultural vehicle.

In the embodiments of the present invention, the position of each component or each part of a component in the front-rear or up-down direction is determined according to the positional relationship in the front-rear direction or up-down direction of the vehicle.

For example, one side close to the front of the vehicle is the front side, and the other side away from the front of the vehicle is the rear side; for example, one edge close to the front of the vehicle is the front edge, and the other edge away from the front of the vehicle is the rear edge; for example, a front view refers to observation from the front of the vehicle to its rear, and a rear view refers to observation from the rear of the vehicle to its front; for example, a top view refers to observation from the top of the vehicle to its bottom, and a bottom view refers to observation from the bottom of the vehicle to its top.

In the following, the rear bumper and the exhaust gas guiding structure with the rear bumper in the embodiments of the present invention are described in combination with the drawings.

### First Embodiment

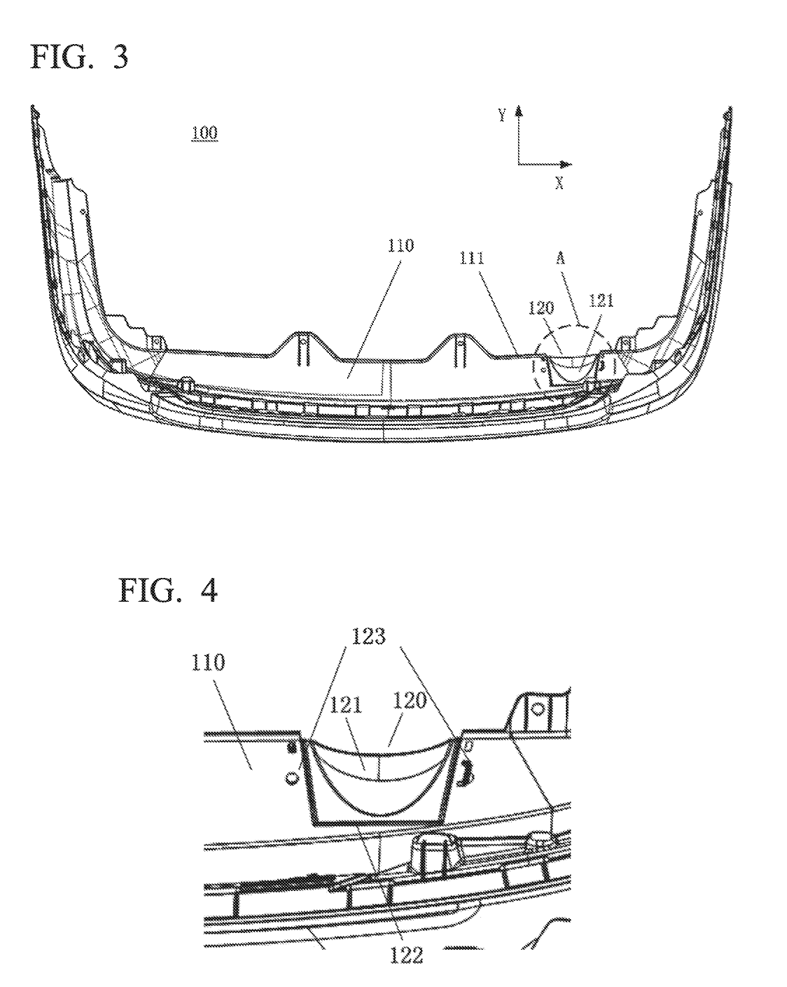

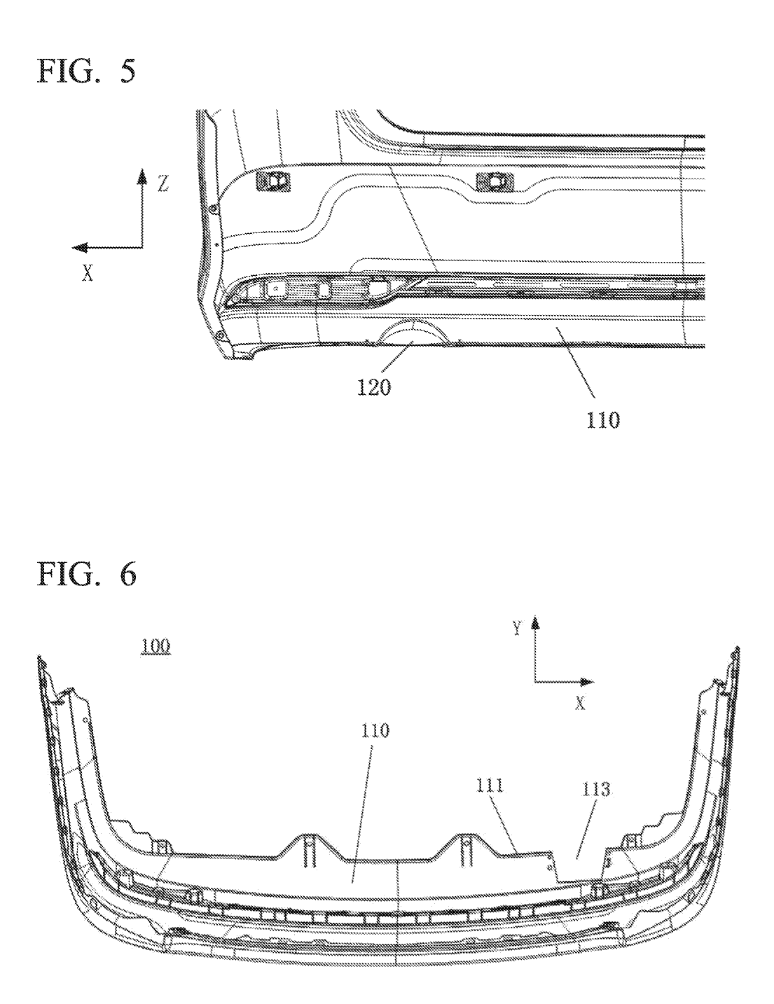

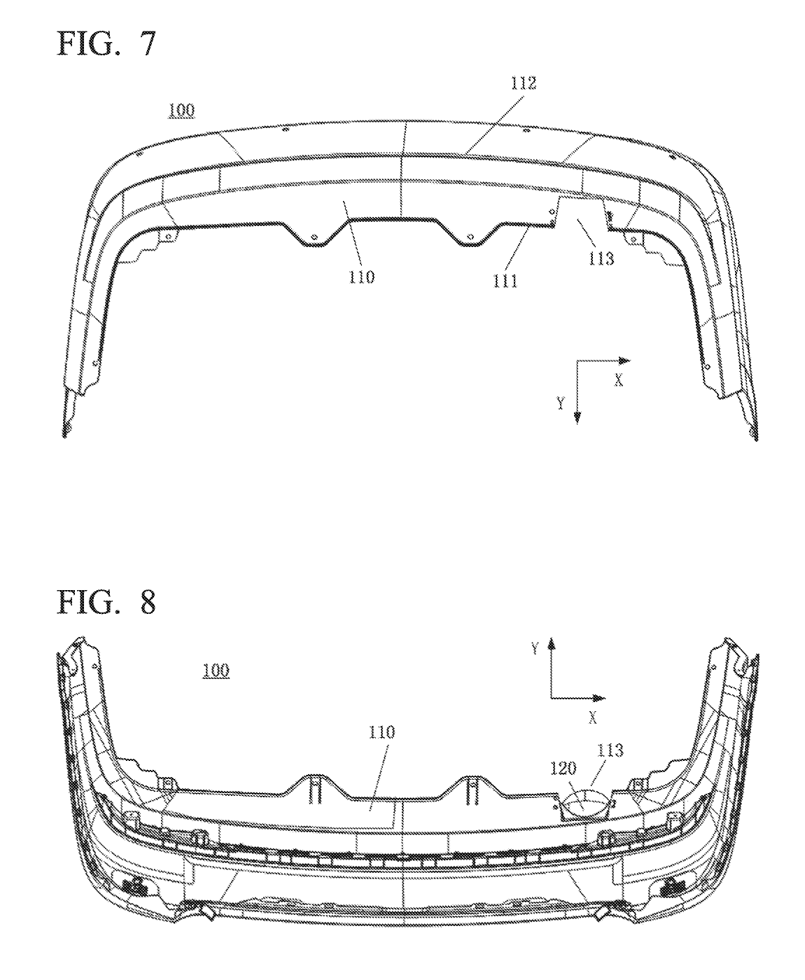

The first embodiment of the present invention provides a rear bumper for a vehicle. FIG. 3 shows a top view of the rear bumper in the first embodiment of the present invention, FIG. 4 shows an enlarged view of the part A in FIG. 3, FIG. 5 shows a front view of the rear bumper in the first embodiment of the present invention, FIG. 6 shows a top view of the rear bumper with the exhaust gas guiding part omitted in the first embodiment of the present invention, and FIG. 7 shows a bottom view of the rear bumper with the exhaust gas guiding part omitted in the first embodiment of the present invention.

As shown in FIG. 3 to FIG. 7, the bumper 100 has a bottom horizontal part 110 and an exhaust gas guiding part 120, wherein the bottom horizontal part 110 is provided with a notch 113 extending from the front edge 111 to the side of the rear edge 112 of the bottom horizontal part, the exhaust gas guiding part 120 is arranged above the notch 113, the exhaust gas guiding part 120 has a protruding part 121 protruding toward above the rear bumper, and the height of the protruding part 121 at the front edge side of the bottom horizontal part 110 is greater than the height of the protruding part 121 at the rear edge side of the bottom horizontal part 110.

X direction represents the lateral direction of the vehicle, and Y direction represents the longitudinal direction of the vehicle, wherein the positive direction (direction indicated by the arrow) of the Y direction represents the front of the vehicle, and the negative direction of the Y direction represents the rear of the vehicle. In other words, the front height of the protruding part 121 is greater than the rear height.

In addition, as shown in FIG. 5, Z direction represents the vertical direction of the vehicle, wherein the positive direction (direction indicated by the arrow) of the Z direction represents the upward of the vehicle, and the negative direction of the Z direction represents the downward of the vehicle.

In the embodiment, the height of the protruding part 121 can be gradually decreased from front to back along the longitudinal direction of the vehicle, which is convenient for the installation of the exhaust pipe and can further achieve that the exhaust pipe is impossible or not easy to see from behind the vehicle, so that the beautiful appearance of the vehicle is achieved.

In the embodiment, the shape of the protruding part 121 can be designed according to actual needs. For example, the cross-section of the protruding part 121 shown in FIG. 3 is an arc-shaped curved surface. In this way, the curvature of the exhaust pipe itself can be reduced, and exhaust gas can be discharged easily.

In the embodiment, the protruding part can also be of other shapes. For example, the protruding part can be formed of multiple oblique planes. In the embodiment, the shape of the protruding part 121 is not restricted.

In the embodiment, the size of the protruding part 121 of the exhaust gas guiding part 120 can be approximately the same as or slightly larger than the size of the notch 113 so as to cover the entire notch 113 in the longitudinal direction. However, the protruding part 121 can also cover a part of the notch 113. In the embodiment, the relative size relationship between the protruding part 121 and the notch 113 is not restricted.

In the embodiment, for example, as shown in FIG. 3, the exhaust gas guiding part 120 is arranged so as not to protrude from the front edge 111 of the bottom horizontal part 110 in the longitudinal direction (Y direction) of the vehicle. In this way, the exhaust pipe arranged in the corresponding position can extend toward the rear of the vehicle so as to further reduce the backflow of exhaust gas into the vehicle.

In the embodiment, for example, as shown in FIG. 6 and FIG. 7, the rear edge of the notch 113 is arranged so as not to protrude from the rear edge 112 of the bottom horizontal part 110, which can further achieve that the exhaust pipe is impossible or not easy to see from behind the vehicle, so that the beautiful appearance of the vehicle is achieved.

In the embodiment, the exhaust gas guiding part 120 and the bottom horizontal part 110 of the rear bumper 100 are integrally formed. In this way, the working procedure and the number of parts can be reduced, the assembly difficulty is further reduced, the assembly accuracy is increased and the cost is saved.

For example, when the exhaust gas guiding part 120 and the bottom horizontal part 110 of the rear bumper 100 are integrally formed, the exhaust gas guiding part 120 can also have a combining section 122. During integral forming, the combining section 122 and the rear edge of the notch 113 are combined to form a hinge structure. In this way, it is further convenient for installation and maintenance through the combination mode of the hinge structure.

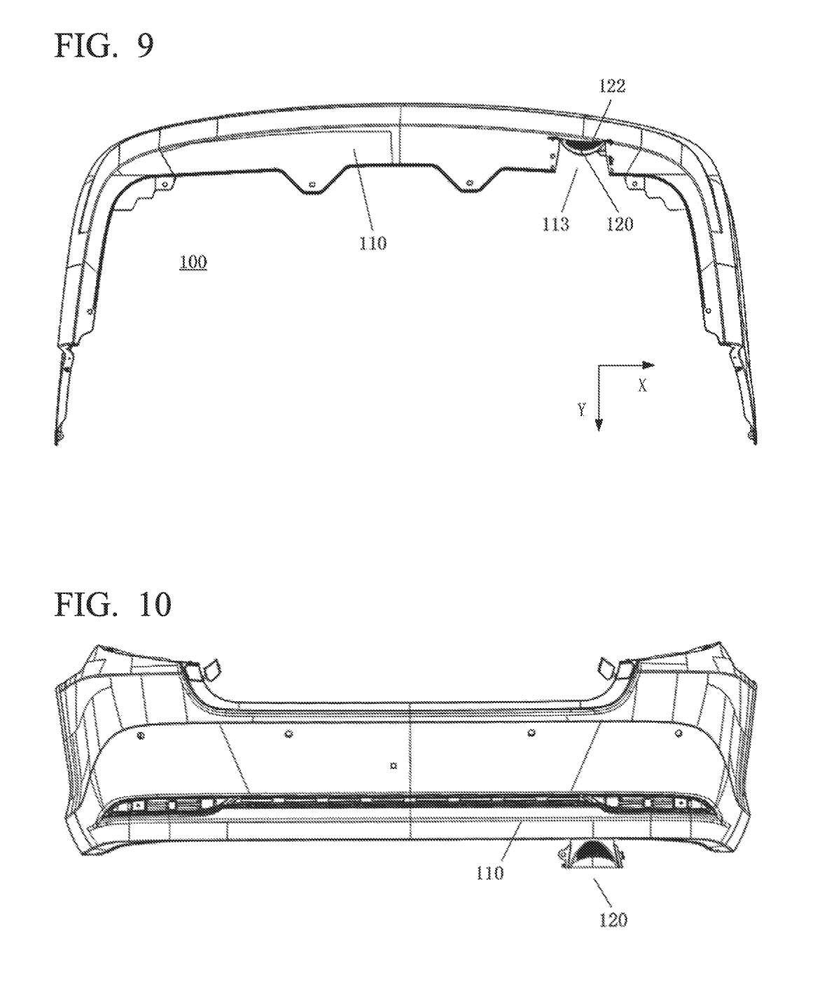

FIG. 8 shows a top view after the exhaust gas guiding part and the bottom horizontal part of the rear bumper are integrally formed in the first embodiment of the present invention, FIG. 9 shows a bottom view after the exhaust gas guiding part and the bottom horizontal part of the rear bumper are integrally formed in the first embodiment of the present invention, and FIG. 10 shows a rear view after the exhaust gas guiding part and the bottom horizontal part of the rear bumper are integrally formed in the first embodiment of the present invention.

As shown in FIG. 8 to FIG. 10, after the working procedure of integral forming is finished, the exhaust gas guiding part 120 and the bottom horizontal part 110 have an angle (for example, about 90°), and the combining section 122 of the exhaust gas guiding part 120 and the rear edge of the notch 113 are combined to form a hinge structure. After integral forming, the formed exhaust gas guiding part 120 can be upturned via the hinge structure, so that the protruding part 121 is embedded in the notch 113 from bottom to top so as to form the structure shown in FIG. 3 to FIG. 5.

In the embodiment, the foregoing describes the example of upturning the formed exhaust gas guiding part 120. In addition, the exhaust gas guiding part 120 can also be designed to be down-turning. The structure is similar and will not be described in detailed any more here.

In the embodiment, as shown in FIG. 4, the exhaust gas guiding part 120 can also have a connecting part 123, the connecting part 123 is connected with the bottom horizontal part 110, so that the exhaust gas guiding part 120 is fixed on the bottom horizontal part 110.

For example, the connecting part 123 is movably or fixedly connected with the bottom horizontal part 110 at one side in the lateral direction of the vehicle. In this way, fixation in movable connection mode is further convenient for installation and maintenance, and the exhaust gas guiding part can be firmly installed on the bottom horizontal part through fixed connection mode.

In the embodiment, the connecting part 123 can be movably connected with the bottom horizontal part 110 at one side in the lateral direction of the vehicle and fixedly connected with the bottom horizontal part 110 at the other side; the connecting part 123 can also be movably connected with the bottom horizontal part 110 at both sides or fixedly connected with the bottom horizontal part 110 at both sides. In addition, the connecting part 123 can also be fixedly connected with the bottom horizontal part 110 only at one side.

In the embodiment, the movable connection can be any of various existing movable connection modes. For example, as shown in FIG. 4, a hook structure is formed at one side of the connecting part 123, and a hanging hole with corresponding shape is formed in the bottom horizontal part 110 so that the hook can be hung to the hanging hole. The hook and the hanging hole have simple structure and can be formed together with the exhaust gas guiding part through a mold, which is convenient for production. However, the embodiment is not limited to such connection mode.

For example, the connecting part 123 can also be fixedly connected with the bottom horizontal part 110 at the other side in the lateral direction of the vehicle. In this way, the exhaust gas guiding part 120 can be firmly installed on the bottom horizontal part 110.

In the embodiment, the fixed connection can be any of various existing fixed connection modes. For example, as shown in FIG. 4, through holes are formed at the other side of the connecting part 123 and in the corresponding position of the bottom horizontal part 110, and the connecting part 123 is fixed by buckles passing through the through holes. The fixation mode by means of the through holes and the buckles is convenient for production, the through holes and the buckles are not easy to damage, and buckle fixation is stable and convenient for operation and replacement. In addition, bolts, nuts or expansion bolts can also be used for fixing. However, the embodiment is not limited to these connection modes.

In the embodiment, the foregoing describes the example of forming the notch and the exhaust gas guiding part at one side of the rear bumper, which is an arrangement for the exhaust pipe of the vehicle in one circumstance. When the vehicle is provided with exhaust pipes at both sides, the notch and the exhaust gas guiding part can be arranged at both sides of the rear bumper, respectively, and the notches and the exhaust gas guiding parts at both sides have the same structures. The specific content will not be repeated any more.

It can be known from the above embodiment that because the bottom horizontal part of the rear bumper is provided with the notch, the notch is provided with the exhaust gas guiding part, and the exhaust gas guiding part and the bottom horizontal part jointly constitute a blocking surface, the blocking surface prevent backflow of exhaust gas, the exhaust gas discharged by the exhaust pipe can be guided outside the vehicle, and backflow of exhaust gas into the vehicle can be effectively reduced; meanwhile, because the height at the front side of the protruding part of the exhaust gas guiding part is greater than the height at the rear side and the rear end of the exhaust pipe is arranged in a position corresponding to the exhaust gas guiding part, the exhaust pipe is impossible or not easy to see from behind the vehicle, so that the beautiful appearance of the vehicle can be achieved; moreover, because the opening of the rear end of the exhaust pipe is far away from the visible face of the rear bumper, the visible face of the rear bumper is not easy to be contaminated by the exhaust gas discharged and has high durability; and in addition, the structure of arranging the notch and arranging the exhaust gas guiding part on the notch is simple, manufacturing and assembly are convenient and the production cost is low.

### Second Embodiment

The second embodiment of the present invention provides an exhaust gas guiding structure. The exhaust gas guiding structure has the rear bumper described in the first embodiment. The structure of the rear bumper will not be repeated any more.

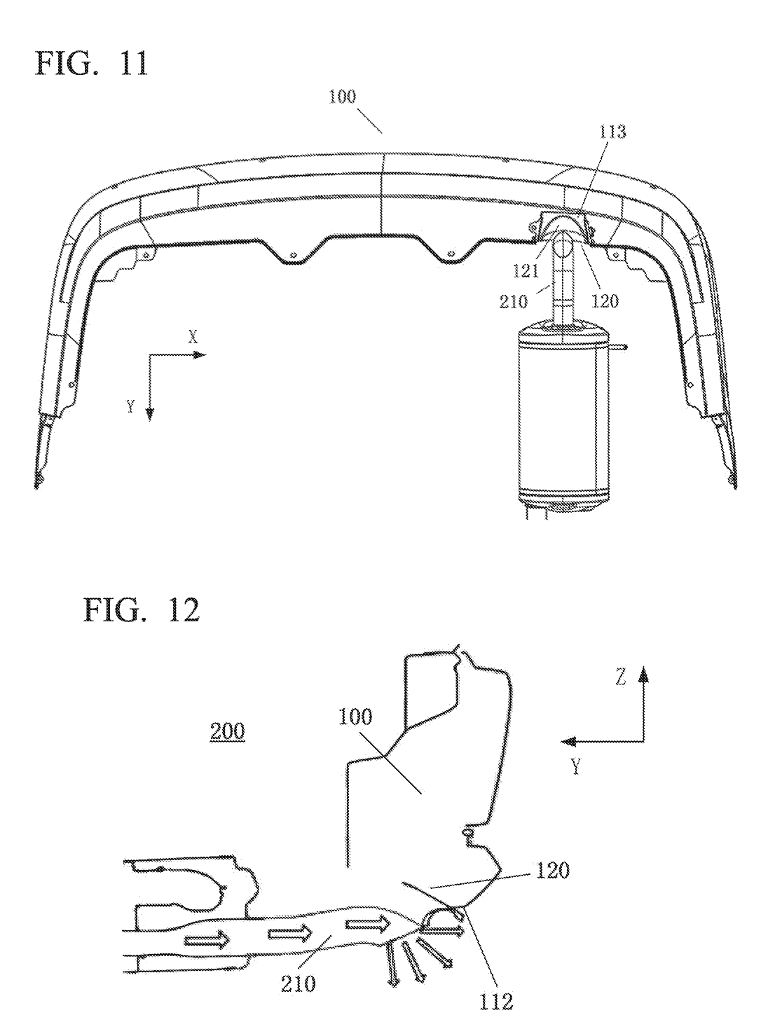

FIG. 11 shows a bottom view of the exhaust gas guiding structure in the second embodiment of the present invention, and FIG. 12 shows a side-section diagram of the exhaust gas guiding structure in the second embodiment of the present invention. As shown in FIG. 11 and FIG. 12, an exhaust gas guiding structure 200 has a rear bumper 100 and an exhaust pipe 210, wherein the structure of the rear bumper 100 is the same as described in the first embodiment, and the rear end of the exhaust pipe 210 is arranged in a position corresponding to the exhaust gas guiding part 120 of the rear bumper 100.

As shown in FIG. 12, exhaust gas discharged by the exhaust pipe 210 can be discharged out of the vehicle according to the direction indicated by the arrow through joint guiding of the exhaust gas guiding part 120 and the rear bumper.

In the embodiment, as shown in FIG. 11, the rear end of the exhaust pipe 210 is arranged so as not to protrude from the rear edge of the notch 113 of the rear bumper 100, which can further achieve that the exhaust pipe is impossible or not easy to see from behind the vehicle, so that the beautiful appearance of the vehicle can be achieved.

In the embodiment, as shown in FIG. 11 and FIG. 12, the rear end of the exhaust pipe 210 is arranged along the shape of the protruding part 121 of the exhaust gas guiding part 120, which can further improve the exhaust gas guiding effect and further achieve that the exhaust pipe is impossible or not easy to see from behind the vehicle, so that the beautiful appearance of the vehicle can be achieved.

In the embodiment, the opening at the rear end of the exhaust pipe 210 is arranged such that the angle between the opening and the horizontal plane is smaller than the predetermined angle. In this way, the plane of the opening is close to the horizontal plane as much as possible, the exhaust pipe is avoided from being seen from behind to the utmost extent while exhaust gas can be discharged, and meanwhile, the effect of preventing backflow of exhaust gas can be further enhanced by changing the discharge direction of the exhaust gas.

In the embodiment, the predetermined angle can be arranged according to actual need. For example, the preset angle can be 45°.

In the embodiment, when one exhaust pipe is arranged on the vehicle, one exhaust gas guiding part is arranged in the corresponding position. When exhaust pipes are arranged at both sides of the vehicle, the exhaust gas guiding part can be arranged at both sides of the rear bumper respectively, and the exhaust gas guiding parts at both sides have the same structures. The specific content will not be repeated any more.

It can be known from the above embodiment that because the bottom horizontal part of the rear bumper is provided with a notch, the notch is provided with an exhaust gas guiding part, and the exhaust gas guiding part and the bottom horizontal part jointly constitute a blocking surface, the blocking surface prevent backflow of exhaust gas, the exhaust gas discharged by the exhaust pipe can be guided outside the vehicle, and backflow of exhaust gas into the vehicle can be effectively reduced; meanwhile, because the height at the front side of the protruding part of the exhaust gas guiding part is greater than the height at the rear side and the rear end of the exhaust pipe is arranged in a position corresponding to the exhaust gas guiding part, the exhaust pipe is impossible or not easy to see from behind the vehicle, so that the beautiful appearance of the vehicle can be achieved; moreover, because the opening at the rear end of the exhaust pipe is far away from the visible face of the rear bumper, the visible face of the rear bumper is not easy to be contaminated by the exhaust gas discharged and has high durability; and in addition, the structure of arranging the notch and arranging the exhaust gas guiding part on the notch is simple, manufacturing and assembly are convenient and the production cost is low.

The embodiments of the present invention are described with reference to the drawings in detail above, indicating the way in which the principle of the present invention can be adopted. However, it should be understood that the present invention is not limited to the forgoing embodiments but includes all alterations, variations and equivalents without departing from the main purpose of the present invention.

What is claimed is:

1. A rear bumper for a vehicle, the rear bumper comprising: a bottom horizontal part and an exhaust gas guiding part;
wherein the bottom horizontal part is provided with a notch extending from a front edge of the bottom horizontal part toward a rear edge side of the bottom horizontal part, and the exhaust gas guiding part is arranged above the notch;
the exhaust gas guiding part includes a protruding part protruding toward above the rear bumper, and a height of the protruding part at the front edge side of the bottom horizontal part is greater than a height of the protruding part at the rear edge side of the bottom horizontal part.

2. The rear bumper according to claim 1, wherein,
the exhaust gas guiding part is arranged so as not to protrude from the front edge of the bottom horizontal part in a longitudinal direction of the vehicle.

3. The rear bumper according to claim 1, wherein:
a rear edge of the notch is arranged so as not to protrude from a rear edge of the bottom horizontal part.

4. The rear bumper according to claim 1, wherein:
the exhaust gas guiding part and the bottom horizontal part of the rear bumper are integrally formed.

5. The rear bumper according to claim 4, wherein:
the exhaust gas guiding part further comprises a combining section, and
the combining section and a rear edge of the notch are combined to form a hinge structure.

6. The rear bumper according to claim 1, wherein:
the exhaust gas guiding part further comprises a connecting part, and
the connecting part is movably or fixedly connected with the bottom horizontal part at one side in a lateral direction of the vehicle.

7. The rear bumper according to claim 1, wherein:
the height of the protruding part is gradually decreased from front to back along the longitudinal direction of the vehicle.

8. The rear bumper according to claim 7, wherein:
a cross-section of the protruding part is an arc-shaped curved surface.

9. An exhaust gas guiding structure comprising:
the rear bumper according to claim 1, and
an exhaust pipe in which a rear end thereof is arranged at a position corresponding to the exhaust gas guiding part of the rear bumper, wherein the rear end of the exhaust pipe is arranged so as not to protrude from the rear end of the notch of the rear bumper in the longitudinal direction of the vehicle.

10. The exhaust gas guiding structure according to claim 9, wherein:
the rear end of the exhaust pipe is arranged along a shape of the protruding part of the exhaust gas guiding part.

11. The exhaust gas guiding structure according to claim 9, wherein:
an opening at the rear end of the exhaust pipe is arranged such that an angle between the opening and a horizontal plane is smaller than a predetermined angle.
